(19) United States
(12) Patent Application Publication
(10) Pub. No.: US 2002/0021259 A1
(43) Pub. Date: Feb. 21, 2002

(54) Image display device

(75) Inventors: Youichi Itaki, Tokyo (JP); Koichi Ara, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC VIEWTECHNOLOGY, LTD.

(21) Appl. No.: 09/925,504

(22) Filed: Aug. 10, 2001

(30) Foreign Application Priority Data
Aug. 11, 2000 (JP) 243942/2000

(51) Int. Cl. G09G 5/00

(52) U.S. Cl. 345/1.1

(57) ABSTRACT

The image display device according to the present invention includes a master display unit and slave display units which respectively display a plurality of pictures that coincide in positions on a projection screen, where the master display unit is equipped with a generation unit that generates an on-screen picture, and the slave display unit is equipped with an erasure unit that erases the portion of the video in a display region corresponding to the on-screen picture.

### BACKGROUND OF THE INVENTION

1 Field of the Invention

The present invention relates to an image display unit, and more particularly to an image display device which makes it possible to display identical images by the use of a plurality of such image display units.

2. Description of the Prior Art

A system that can display an overlapped picture (screen image) of a plurality of identical pictures by the use of a plurality of picture display units has been developed by the present inventors. Such a display system is expected to be effective when it is desired to have a brighter picture than in the case it is displayed by using a single display unit.

In such a display system, in executing an on-screen display, such as an image adjustment menu employed for screen adjustment, on-screen displays that correspond respectively to the plurality of display units are displayed overlapped on one screen. As a result, there arises a problem that it is difficult to apply image adjustment to individual display units.

The purpose of the present invention is to provide a connected display device and a method of connected display that makes it possible to display an on-screen picture sharp and in a manner easy to look at.

### BRIEF SUMMARY OF THE INVENTION

Object of the Invention

It is the object of the present invention to provide an image display device which makes it possible to view individual on-screen images when a plurality of image display units are used at the same time.

Summary of the Invention

The image display device according to this invention includes a master image display unit (referred to simply as master display unit) and slave image display units (referred to simply as slave display units) which display individually a plurality of pictures coinciding in position on the screen. The master display unit is equipped with a generator that generates an on-screen picture, and the slave display unit is equipped with an eraser that erases the picture portion in the display region corresponding to the on-screen picture.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is an equipment block diagram showing an embodiment according to the invention in which a plurality of image display units are connected:

FIG. 2 is a circuit block diagram showing details of the image display unit: and

FIG. 3 is a picture diagram showing an example of connected display according to the invention.

### DETAILED DESCRIPTION OF THE INVENTION

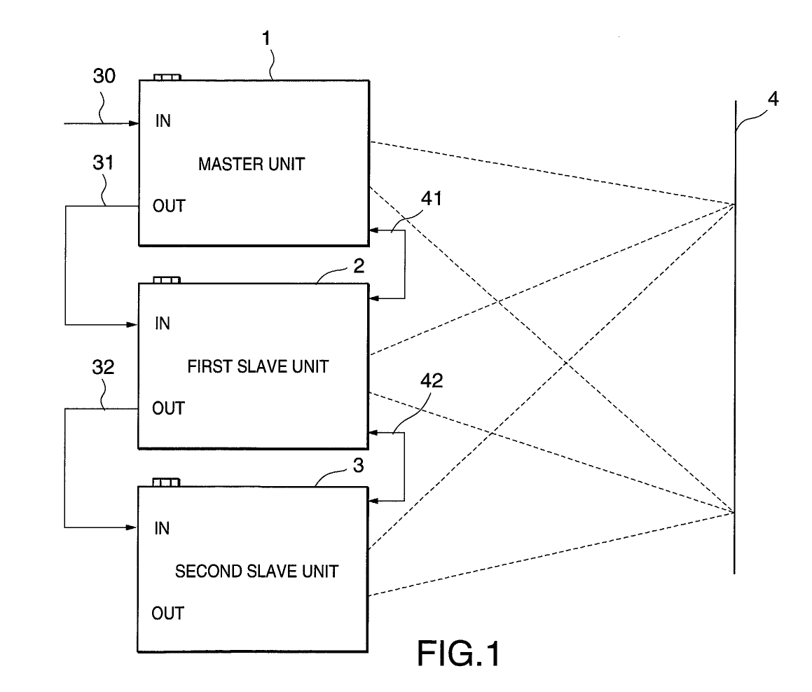

The present invention discloses an image display device that projects an image using a plurality of image display units. The plurality of image display units consist of a master display unit 1, a first slave display unit 2 and a second slave display unit 3 as shown in FIG. 1. The master display unit 1, the first slave display unit 2 and the second display unit 3 are arranged facing a common screen 4.

The master display unit 1, the first slave display unit 2 and the second slave display unit 3 are capable of displaying an exactly the same picture on the screen 4. Moreover, by increasing the number of overlapping of the identical pictures through addition of other display units, it is possible to enhance the bright portions of a singly projected picture on the screen still more.

A picture signal 30 to be reproduced is input to the master display unit 1, the same picture signal 30 is output from the master display unit 1 and is input to the first slave display unit 2 via a first picture cable 31, and the picture signal the same as the picture signal 30 input to the first slave display unit 2 is output from the first display unit 2 and is input to the second display unit 3 via a second picture cable 32.

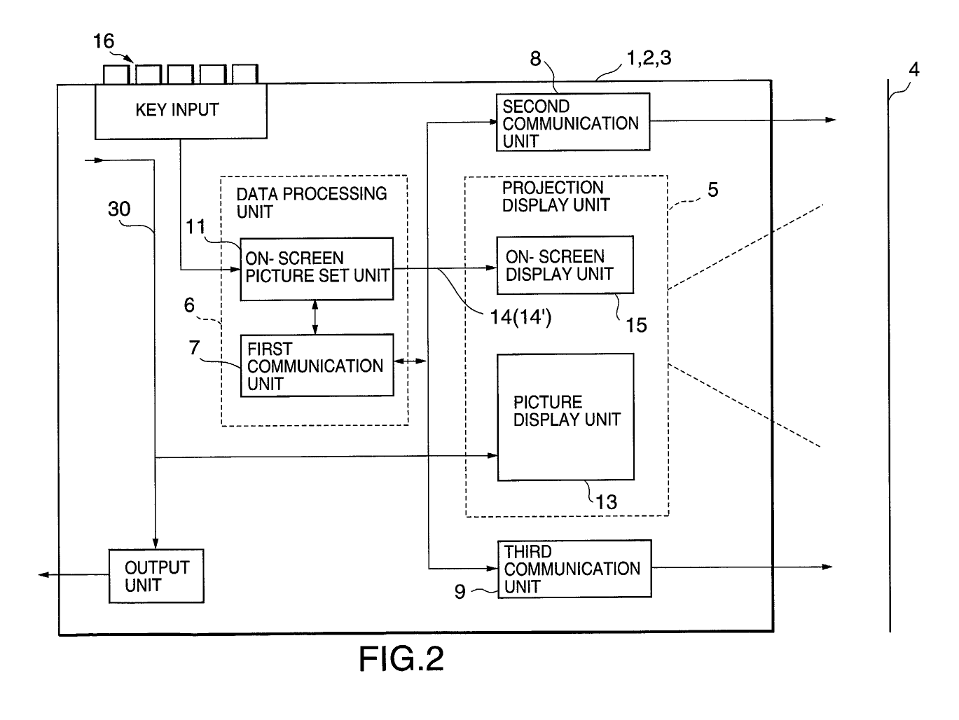

The master display unit 1, the first slave display unit 2 and the second slave display unit 3 are precisely the same system as shown in FIG. 2. However, the master display unit 1 is different from the first slave display unit 2 and the second display unit 3 in the manner in which these units are used. Except for the cases where special distinction among them is required, the master display unit 1, the first slave display unit 2 and the second slave display unit 3 will generically be referred to as display unit, and will be represented by display unit 1. The display unit 1 comprises a projection display unit 5 which generates a picture projected on the screen 4, a data processing unit 6 and communication units. The communication units comprises a first communication unit 7 which is included in the data processing unit 6 and is used commonly for transmission and reception, a second communication unit 8 used for reception (or for transmission) and a third communication unit 9 used for transmission (or for reception).

The data processing unit 6 comprises an on-screen picture set unit 11 which sets an on-screen picture and the first communication unit 7. The projection display unit 5 comprises a picture display unit 13 which generates a basic picture based on the picture signal 30 input to the display unit 1 and an on-screen picture display unit 15 which generates and displays an on-screen picture based on on-screen data 14 set by the on-screen picture set unit 11 and is output from the on-screen picture set unit 11. The projection display unit 5 projects a picture generated by the picture display unit 13 and the on-screen picture display unit 15 on the screen 4.

Although the first communication unit 7 may be connected bidirectionally to the second communication unit 8 and the third communication unit 9, in the actual use, the second communication unit 8 is connected unidirectionally to the first communication unit 7 and the first communication unit 7 is connected unidirectionally to the third communication unit 9. The display unit 1 is equipped with a key group 16 by which the on-screen data 14 can be input to the on-screen picture set unit 11 through key operation.

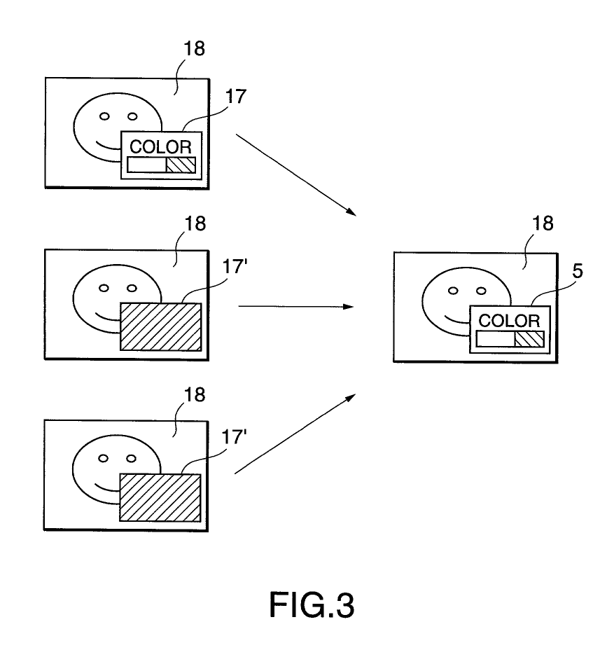

On-screen data 14 that are input to and set at the on-screen picture set unit 11 of the master display unit 1 are input to the on-screen picture display unit 15 of the master display unit 1, and an on-screen picture is formed, as shown in FIG. 3(a), on the on-screen picture display unit 15 based on the on-screen data. The on-screen picture 17 is overwritten on the basic picture 18.

On-screen data or data (for example, data of the frame alone of the on-screen picture 17, which will be represented by an the on-screen data 14′ hereinafter).are output from the master display unit 1 via the first communication unit 7 of the master display unit 1 and the third communication unit 9 of the master display unit 1 and are input to the first slave display unit 2, and the on-screen data 14 are input to the on-screen data set unit 11 of the first slave display unit 2 via the second communication unit 8 of the first slave display unit 2 and the first communication unit 7 of the first slave display unit 2.

The on-screen picture set unit 11 of the first slave display unit 2 outputs the on-screen data 14′ that correspond to the on-screen data 14 but are not the same as the on-screen data 14, and the on-screen data 14′ are input to the on-screen picture display unit 15 of the first slave display unit 2. Based on the on-screen data 14′, the on-screen picture display unit 15 of the first slave display unit 2 erases the portion of the basic picture 18 of the same on-screen picture region that corresponds to the on-screen picture 17 of the on-screen picture display unit 15 of the master display unit 1. The erasure means, for example, to paint out in black a portion of the basic picture 18 of the on-screen picture region as shown in FIG. 3.

The on-screen data 14′ are output from the first slave display unit 2 via the first communication unit 7 of the first slave display unit 2 and the third communication unit 9 of the first slave display unit 2, and are input to the on-screen picture set unit 11 of the second slave display unit 3 via the second communication unit 8 of the second slave display unit 3 and the first communication unit 7 of the second slave display unit 3. The on-screen picture set unit 11 of the second slave display unit 3 outputs the on-screen data 14′ that are the same as the on-screen data 14′, and the on-screen data 14′ are input to the on-screen picture display unit 15 of the second slave display unit 3.

Based on the on-screen data 14′, the on-screen picture display unit 15 of the second slave display unit 3 erases the portion of the basic picture 18 of the same on-screen picture region that corresponds to the on-screen picture 17 of the on-screen picture display unit 15 of the master display unit 1. The erasure is, for example, to paint out in black a portion of the basic picture 18 of the on-screen picture region as shown in FIG. 3(c).

Since the information quantity of the on-screen picture 17′ of the on-screen picture display unit 15 of the first slave display unit 2 and the on-screen picture 17′ of the on-screen picture display unit 15 of the second slave display unit 3 is essentially zero, the on-screen picture 17 of the on-screen picture display unit 15 of the master display unit 1 alone is projected on the display region. However, the outline of the portion painted out in black of the on-screen picture 17′ remains as the frame line.

The on-screen picture is an adjustment menu of the projected image such as the color adjustment menu. The operator manipulates the master display unit 1 by means of a remote control unit while watching the menu to execute various kinds of screen adjustments. It is to be noted that the on-screen picture is not formed only on the master display unit 1, but another on-screen picture is also formed on the first slave display unit 2 or the second slave display unit 3.

In this case, black painting corresponding to the on-screen picture formed on the first slave display unit 2 is executed to the master display unit 1 and the second slave display unit 3. The exchange of the functions of the master display unit 1 and the first slave display unit 2 is feasible. With such an exchange, the master display unit 1 functions as a slave display unit, and the first slave display unit 2 serves as the master display unit. Since the master display unit 1, the first slave display unit 2 and the second slave display unit 3 are precisely identical systems and there exists no difference among them with respect to their functions, the mass productivity of the device is high.

A larger number of display units may be arranged two-dimensionally (in rows and columns) Moreover, the identical picture signals 30 may be input to a plurality of display units in parallel instead of being input sequentially to the plurality of display units.

Although the invention has been described with reference to a specific embodiment, this description is not meant to be construed in a limiting sense. Various modifications of the disclosed embodiment will become apparent to persons skilled in the art upon reference to the description of the invention. It is therefore contemplated that the appended claims will cover any modifications or embodiments as fall within the true scope of the invention

What is claimed is:

1. In an image display device including a master display unit and slave display units that display respectively a plurality of pictures coinciding in positions on a projection screen, the image display device characterized in that said master display unit is equipped with a generation unit which generates an on-screen picture, and said slave display unit is equipped with an erasure unit which erases the portion of said picture in display region corresponding to said on-screen picture.

2. The image display device as claimed in claim 1, wherein said erasure unit has a function of displaying an image in which said display region is painted out in black.

3. The image display device as claimed in claim 1, wherein each of said plurality of display units is equipped with an on-screen picture set unit, an on-screen display unit that displays said on-screen picture and an on-screen data communication unit, the on-screen picture set unit of said master display unit sets said on-screen picture to be displayed on said on-screen display unit, on-screen data corresponding to the on-screen picture set in the on-screen picture set unit of said master display unit are transmitted to said on-screen picture set unit of said slave display unit via the on-screen data communication unit of said master display unit and the on-screen data communication unit of said slave display unit, and the on-screen display unit of said slave display unit is the same as said erasure unit.

4. The image display device as claimed in claim 3, wherein said on-screen communication unit is equipped with a first on-screen data communication unit, a second on-screen data communication unit and a third on-screen data communication unit, and said on-screen data are transmitted to said on-screen picture set unit of said slave display unit via said first on-screen data communication unit of said master display unit, said third on-screen data communication unit of said master display unit, said second on-screen data communication unit of said slave display unit and said first on-screen data communication unit of said slave display unit.

5. The image display device as claimed in claim 4, wherein said slave display unit is equipped with a first slave display unit and a second slave display unit, and said on-screen data of the on-screen picture set unit of said first slave display unit are transmitted to said on-screen picture set unit of said second slave display unit via said first on-screen data communication unit of said first slave display unit, said third on-screen data communication unit of said first slave display unit, said second on-screen data communication unit of said second slave display unit and said first on-screen data communication unit of said second slave display unit.

6. The image display device as claimed in claim 1, wherein an arbitrary display unit of said plurality of display units may be selected as either one of said master display unit or said slave display unit.
